(19) United States
(12) Patent Application Publication
(10) Pub. No.: US 2021/0023405 A1
(43) Pub. Date: Jan. 28, 2021

(54) FIRE EXTINGUISHER WITH AN AUDITORY INSTRUCTION MODULE

(71) Applicant: Jeffrey P. Werner, Sheridan, IL (US)

(72) Inventor: Jeffrey P. Werner, Sheridan, IL (US)

(21) Appl. No.: 16/939,631

(22) Filed: Jul. 27, 2020

Related U.S. Application Data
(60) Provisional application No. 62/922,098, filed on Jul. 25, 2019.

(51) Int. Cl. A62C 13/76; A62C 99/00; G09B 21/00

(52) U.S. Cl. CPC A62C 13/76; G09B 21/006; A62C 99/0081

(57) ABSTRACT

The present invention is directed to a fire extinguisher having a built-in module for providing auditory instructions on how to use the fire extinguisher properly in an emergency situation. The present invention features a fire extinguisher comprising a chamber for holding extinguishing chemicals and a cap screwably attached to the chamber. The cap may comprise a release valve, a handle for activating the release valve, a safety pin for preventing activation of the handle before safety pin removal, a nozzle for directing extinguishing chemicals, and a pressure gauge. The fire extinguisher may further comprise an instructional module disposed in the cap for relaying audio instructions through a speaker. The speaker may be actuated by an activation mechanism disposed on the cap.

### CROSS-REFERENCES TO RELATED APPLICATIONS

This application is a non-provisional and claims benefit of U.S. Provisional Application No. 62/922,098 filed Jul. 25, 2019, the specification of which is incorporated herein in its entirety by reference.

### FIELD OF THE INVENTION

The present invention is directed to a fire extinguisher having a built-in module for providing auditory instructions on how to use the fire extinguisher properly in an emergency situation.

### BACKGROUND OF THE INVENTION

In the event of a fire, fast and precise action is required to stop the spread early and prevent the fire from escalating. For these situations, a fire extinguisher is the most common tool used by a civilian to extinguish a fire before emergency personnel arrives, but many civilians do not know the proper way to use these tools. Existing fire extinguishers implement a set of instructions printed on the external shell of the chamber to teach a civilian how to use the fire extinguisher properly. However, trying to read the small printed instructions on the fire extinguisher while trying to follow said instructions wastes precious time needed to handle fire emergencies. Furthermore, vision-impaired civilians would be completely unable to read the instructions and would be unable to learn how to use the fire extinguisher properly. Thus, a present need exists for a fire extinguisher capable of quickly and efficiently relaying instructions for use to a civilian regardless of their prior knowledge or visual abilities.

### BRIEF SUMMARY OF THE INVENTION

It is an objective of the present invention to provide devices that allow for a fire extinguisher having a built-in module for providing auditory instructions on how to use the fire extinguisher properly in an emergency situation, as specified in the independent claims. Embodiments of the invention are given in the dependent claims. Embodiments of the present invention can be freely combined with each other if they are not mutually exclusive.

The present invention features a fire extinguisher for providing auditory instructions to a user. In some embodiments, the fire extinguisher may comprise a chamber for holding a mixture of extinguishing chemicals. The fire extinguisher may further comprise a cap screwably attached to the chamber at an opening. The cap may comprise a release valve and a handle operatively connected to the release valve such that actuating the handle causes the release valve to open. The cap may further comprise a safety pin removably disposed through the handle for preventing actuation of the handle until the safety pin is removed. The cap may further comprise a nozzle fluidly connected to the chamber for directing the mixture of extinguishing chemicals when the handle is actuated, and a pressure gauge for measuring a status of pressure within the chamber. The fire extinguisher may further comprise an instruction module disposed within the cap comprising a battery, a speaker, and a memory unit containing a plurality of instructional audio files and instructions for playing the plurality of instructional audio files through the speaker. The instruction module may further comprise a processor operatively connected to speaker and the memory unit for executing instructions held in the memory unit. The instruction module may further comprise an activation component for actuating the processor to play the plurality of instructional audio files through the speaker. The fire extinguisher may further comprise a battery LED for indicating a charge status of the battery, a wireless communicator for sending an alert to an emergency center upon actuating the fire extinguisher, and a wireless LED for indicating a wireless connectivity status of the wireless communicator.

One of the unique and inventive technical features of the present invention is the speaker for playing a plurality of instructional audio files. Without wishing to limit the invention to any theory or mechanism, it is believed that the technical feature of the present invention advantageously provides for efficient conveyance of instructions on how to use the fire extinguisher in order to teach civilians how to deal with a fire emergency more quickly. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a full view of a fire extinguisher of the present invention.

FIG. 2 shows an embodiment of a cap of a fire extinguisher of the present invention.

FIG. 3 shows a close-up view of the top of a fire extinguisher of the present invention.

### DETAILED DESCRIPTION OF THE INVENTION

Following is a list of elements corresponding to a particular element referred to herein:
100 chamber
110 external shell
120 opening
200 cap
210 handle
220 safety pin
230 nozzle
240 pressure gauge
300 speaker
310 activation component
320 battery LED
330 wireless LED

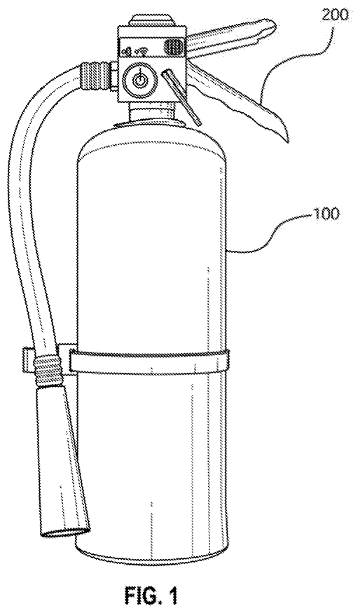

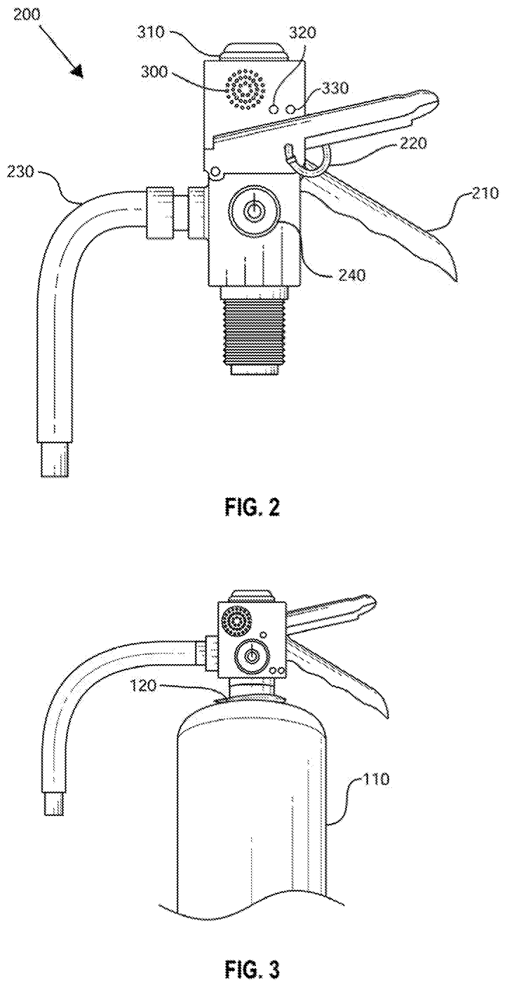

Referring now to FIGS. 1-3, the present invention features a fire extinguisher for providing auditory instructions to a user. In some embodiments, the fire extinguisher may comprise a chamber (100). The chamber (100) may comprise an external shell (110) and an opening (120). A mixture of extinguishing chemicals may be contained within the chamber (100). The fire extinguisher may further comprise a cap (200) screwably attached to the chamber (100) at the opening (120). The cap (200) may comprise a release valve disposed at the opening (120) and a handle (210) operatively connected to the release valve. Actuating the handle (210) may cause the release valve to move from a closed state to an open state. The cap (200) may further comprise a safety pin (220) removably disposed through the handle (210) for preventing actuation of the handle (210) until removal of the safety pin (220). The cap (200) may further comprise a nozzle (230) fluidly connected to the chamber (100) for directing the mixture of extinguishing chemicals upon actuation of the handle (210) and a pressure gauge (240) for measuring a status of pressure within the chamber (100). The fire extinguisher may further comprise an instruction module disposed within the cap (200). The instruction module may comprise a battery, a speaker (300), and a memory unit comprising a plurality of instructional audio files and instructions for playing the plurality of instructional audio files through the speaker (300). The instruction module may further comprise a processor operatively connected to speaker (300) and the memory unit. The processor may be capable of executing instructions held in the memory unit. The instruction module may further comprise an activation component (310) for actuating the processor to execute instructions held in the memory unit.

In some embodiments, the fire extinguisher may further comprise a battery LED (320) for indicating a charge status of the battery. In some embodiments, the fire extinguisher may further comprise a wireless communicator and the memory unit may further comprise instructions for using the wireless communicator to send an alert to an emergency center upon actuating the fire extinguisher. The fire extinguisher may further comprise a wireless LED (330) for indicating a wireless connectivity status of the wireless communicator. A plurality of additional LED lights may be included to display additional information. In some embodiments, the activation component (310) may comprise a button. In some embodiments, the mixture of extinguishing chemicals may comprise nitrogen, carbon dioxide, potassium bicarbonate, liquid water, and/or evaporating fluorocarbon. In some embodiments, the handle (210) may comprise a squeezable handle.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A fire extinguisher for providing auditory instructions to a user comprising:
a. a chamber (100) comprising:
i. an external shell (110); and
ii. an opening (120);
wherein a mixture of extinguishing chemicals are contained within the chamber (100);
b. a cap (200) screwably attached to the chamber (100) at the opening (120), the cap (200) comprising:
i. a release valve disposed at the opening (120);
ii. a handle (210) operatively connected to the release valve, wherein actuating the handle (210) causes the release valve to open;
iii. a safety pin (220) removably disposed through the handle (210) for preventing actuation of the handle (210) until removal of the safety pin (220);
iv. a nozzle (230) fluidly connected to the chamber (100) for directing the mixture of extinguishing chemicals upon actuation of the handle (210); and
v. a pressure gauge (240) for measuring a status of pressure within the chamber (100); and
c. an instruction module disposed within the cap (200), the instruction module comprising:
i. a battery;
ii. a speaker (300);
iii. a memory unit comprising:
1. a plurality of instructional audio files, and
2. instructions for playing the plurality of instructional audio files through the speaker (300);
iv. a processor operatively connected to speaker (300) and the memory unit, wherein the processor is capable of executing instructions held in the memory unit; and
v. an activation component (310) for actuating the processor to execute instructions held in the memory unit.

2. The fire extinguisher of claim 1 further comprising a battery LED (320) for indicating a charge status of the battery.

3. The fire extinguisher of claim 1 further comprising a wireless communicator.

4. The fire extinguisher of claim 3, wherein the memory unit further comprises instructions for using the wireless communicator to send an alert to an emergency center upon actuating the fire extinguisher.

5. The fire extinguisher of claim 4 further comprising a wireless LED (330) for indicating a wireless connectivity status of the wireless communicator.

6. The fire extinguisher of claim 1, wherein the activation component (310) comprises a button.

7. The fire extinguisher of claim 1, wherein the mixture of extinguishing chemicals comprises nitrogen, carbon dioxide, potassium bicarbonate, liquid water, and/or evaporating fluorocarbon.

8. The fire extinguisher of claim 1, wherein the handle (210) comprises a squeezable handle.
